(19) United States
(12) Patent Application Publication
(10) Pub. No.: US 2026/0350629 A1
(43) Pub. Date: Nov. 5, 2026

(54) Problem Identification and Classification Using a Large Language Model for Responding to Complaints

(71) Applicant: Maplebear Inc., San Francisco, CA (US)

(72) Inventor: Naval Shah, Toronto (CA)

(21) Appl. No.: 19/194,755

(22) Filed: Apr. 30, 2025

(51) Int. Cl. G06Q 30/016; G06F 40/35; H04L 51/02; H04L 51/216

(52) U.S. Cl. CPC G06Q 30/016; G06F 40/35; H04L 51/02; H04L 51/216

(57) ABSTRACT

Problem classification of items using a machine learning model (e.g., a large language model) is described. Message data associated with a message is gathered by an online system. The message is from a user device associated with a user and the message describes a complaint that relates to an order associated with the user. The machine learning model is prompted based in part on the message data to identify one or more items of the order that are relevant to the complaint, the quantities of the one or more items, and problem classifications of the one or more items. For the one or more items, a response recommendation is generated based in part on the one or more quantities and the one or more problem classifications. A response to the complaint is provided to the user device, where the response is based in part on the response recommendation

### BACKGROUND

Conventional online platforms may use chatbots to answer basic questions from customers. However, such chatbots are limited in the services they can provide. For example, artificial intelligence powered chatbots can hallucinate, which is particularly problematic in situations where the standard for accuracy is very high (e.g., answering legal questions).

Another issue is that a user may intend to file a complaint, but not provide enough context in order for the complaint to be answered responded to by the AI chatbot. For these reasons, human agents are often used to service complaints. But the use of human agents can result in inconsistent results in resolving complaints. This can be particularly true, for human agents tasked with resolving errors in large, complicated orders, where it can be difficult to identify errors in order to provide appropriate remediations.

Additionally, current systems lack efficient and technically reliable mechanisms for interpreting unstructured complaint messages to determine specific order item issues and appropriate responses. Specifically, existing approaches do not adequately use contextual order data in combination with machine learning models to classify problems at the item level. As a result, these systems fail to consistently and accurately identify the scope of the complaint or the appropriate remediation actions. This presents a technical problem rooted in computer functionality-specifically, the need for improved automated techniques to parse, interpret, and respond to user complaints with greater precision and consistency.

### SUMMARY

In accordance with one or more aspects of the disclosure, problem classification of items using a machine learning model (e.g., a large language model) for responding to complaints is described. An online system receives one or more messages from a user client device (“user device”) associated with a user. The one or more messages may describe a complaint that relates to an order associated with the user. The online system may gather message data associated with the message. The online system may prompt the machine learning model using the message data to identify one or more items of the order that are relevant to the complaint (e.g., missing items, wrong items, damaged items, etc.), quantities of the one or more items, or one or more problem classifications of the one or more items. The online system may generate, for the one or more items, a response recommendation (e.g., refund, etc.) based in part on the one or more problem classifications and the quantities of the one or more items.

The online system may provide a response to the user device that is based in part on the response recommendation. For example, in some embodiments, the response recommendation is the response, and the online system provides the response directly to the user device. In another example, the online system provides the response recommendation to an agent device for review by an associated human agent. For example, the online system may gather session information (e.g., some or all of the message data, the identified one or more items, and the response recommendation) associated with the complaint, and provide the session information to an agent device. The online system may receive a response to the complaint from the agent device that is based in part on the response recommendation, and the online system then provides the response to the user device. In some embodiments, the online system may send the response recommendation to the human agent for review if one or more conditions are met, and if not, send the response recommendation directly to the user device as the response to the complaint.

Moreover, the machine learning model may be fine-tuned using feedback from the user device or the agent device. For example, the online system may receive feedback from the agent device on the response recommendation and receive feedback from the user device on the response. The online system may generate additional training examples based in part on the feedback from the agent device and the feedback from the user device. The online system may fine tune the LLM using the additional training examples.

By integrating a trained machine learning model with structured order data and dynamically gathered complaint context, the online system provides a specific improvement to the functioning of computer-based complaint resolution systems. For example, rather than performing generalized language analysis or mere data retrieval, the approach applies a trained model to classify complaint types and associate them with individual order items, enabling downstream decisioning logic to generate actionable response recommendations. This represents a technical solution to the technical problem of processing ambiguous or incomplete complaint messages at scale, and facilitates automated, accurate, and contextually relevant remediation decisions that improve upon conventional manual or rule-based approaches.

In the above manner, the online system is able to leverage using a machine learning model to facilitate providing consistent and accurate responses to complaints in a time efficient manner. This can be particularly helpful for responding to complaints relating to large or complex orders which can be difficult tasks for human agents to perform in a consistent, accurate, and time efficient manner.

### BRIEF DESCRIPTION OF THE DRAWINGS

FIG. 1 illustrates an example system environment for an online system that is part of an organization, in accordance with one or more embodiments.

FIG. 2 illustrates an example system architecture for an online system, in accordance with some embodiments.

FIGS. 3A-3B form an example sequence diagram for responding to complaints based in part on classifications of items using a complaint analysis model, in accordance with some embodiments.

FIG. 4 is a flowchart for a method of generating responses to complaints based in part on classifications of items using a complaint analysis model, in accordance with some embodiments.

### DETAILED DESCRIPTION

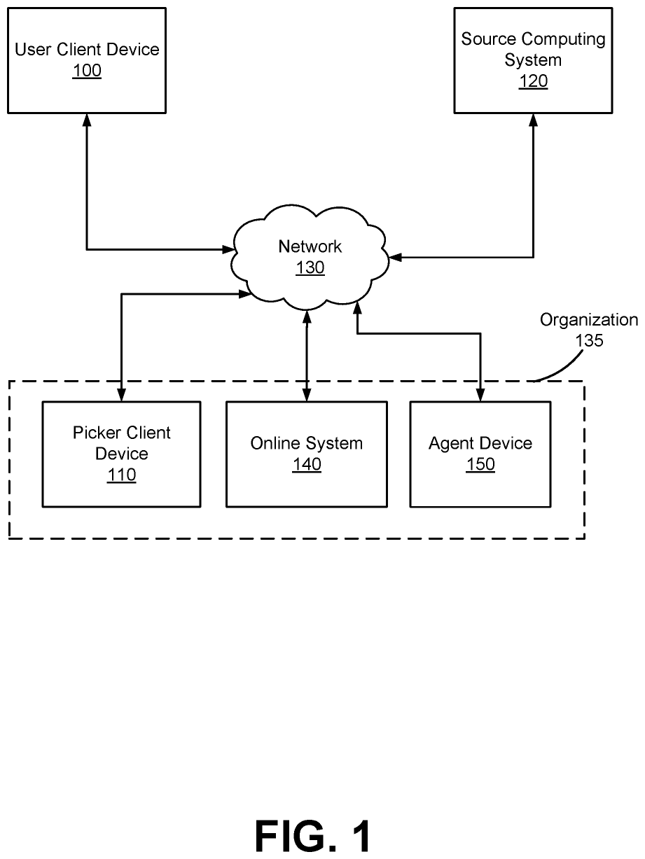

FIG. 1 illustrates an example system environment for an online system 140 that is part of an organization 135, in accordance with one or more embodiments. The system environment illustrated in FIG. 1 includes a user client device 100, a picker client device 110, a source computing system 120, a network 130, an online system 140, and an agent device 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The organization 135 includes the online system 140, the agent device 150, and the picker client device 110. Although one user client device 100, picker client device 110, agent device 150, and source computing system 120 are illustrated in FIG. 1, any number of users, pickers, human agents, and sources may interact with the online system 140. As such, there may be more than one user client device 100, picker client device 110, agent device 150, source computing system 120, or some combination thereof.

The user client device 100 is a client device through which a user may interact with the picker client device 110, the source computing system 120, the agent device 150, or the online system 140. The user client device 100 may be referred to as a “user device.” The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may establish a session between the user and the online system 140. The session may be, e.g., an online chat session, an email session, a phone session, etc. In some embodiments, the user client device 100 may present the online chat session via a chat interface. In some embodiments, the chat interface is part of the ordering interface. The chat interface may be part of a client application operating on the user client device 100.

A user may submit a complaint about an order to the online system 140 via a session. For example, the user may submit a complaint in an online chat session (e.g., via the chat interface). The complaint may include, e.g., order details (e.g., order data), details regarding one or more problems of the order (e.g., ordered 1% milk, but whole milk was delivered), one or more images (e.g., images of damaged items, spoiled items, etc.), or some combination thereof. Details of the order or some or all of the details regarding the one or more problems may be captured as structured data, unstructured data, or some combination thereof. The online system 140 provides the complaint to the online system 140. In some embodiments, once the complaint is resolved, the user client device 100 receives a response to the complaint from the online system 140. The user client device 100 may present the response to the user as part of the session. The response provides some description regarding how the complaint was resolved. For example, the user client device 100 may present in the chat interface the response to the complaint (e.g., full or partial refund for a problematic part of the order).

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the agent device 150, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The organization 135 is an entity (e.g., business entity) that operates the online system 140. An agent device 150 is operated by a human agent of the organization 135. The agent device 150 can be a personal or mobile computing device, such as a smartphone, a tablet, a laptop computer, or desktop computer. In some embodiments, the agent device 150 executes a client application that uses an API to communicate with the online system 140. The human agent may be tasked with, e.g., reviewing response recommendations (e.g., recommending some form of appeasement) generated by the online system 140. For example, the agent device 150 may receive session information associated with a complaint from the online system 140. The session information is information (e.g., response recommendation) that may be used to determine a resolution to the complaint. In some embodiments, the human agent reviews the session information and determines a response to the complaint based in part on the session information. The human agent may then instruct the online system 140 (e.g., via the agent device 150) to provide the response to the user client device 100. In some embodiments, the response recommendation is presented via the agent device 150 to the human agent along with an option for the human agent to approve or disregard the response recommendation. And if the human agent approves the response recommendation, the agent device 150 may coordinate with the online system 140 to provide a response to the user client device 100 describing the response recommendation (e.g., refunding money for the defective items).

In some embodiments, the human agent is able to provide, via the agent device 150, the response to the user client device 100 during the online chat session. In other embodiments, the human agent provides, via the agent device 150, the response to the user client device 100 sometime after the online chat session via a communication channel (e.g., email, phone, etc.). For example, once the online system 140 provides the session information to the human agent, it may also notify the user client device 100 of the transfer and let the user know a ticket has been created for their question and that the human agent will be contacting them at a later time to resolve their question.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 processes complaints from user client devices. The online system 140 may receive one or more messages from the user client device 100 that describe a complaint that relates to an order associated with the user. For example, some of the items of the order may have been damaged during shipment. The online system 140 gathers corresponding message data (e.g., context about the complaint, order data for the order associated with the complaint, item data for items in the order, one or more images provided by the user client device 100, etc.). The online system 140 may prompt a complaint analysis model (i.e., a machine learning model) using the message data to identify one or more items of the order that are relevant to the complaint, determine quantities of the one or more items, and determine one or more problem classifications for the one or more items. A problem classification describes how severely an item that is relevant to the complaint (e.g., missing item, damaged item, wrong item, etc.) differs from what was actually ordered

The online system 140 may determine, for the identified one or more items, a response recommendation that is based in part on the one or more problem classifications and the quantities of the identified one or more items. In some embodiments, the online system 140 may retrieve a set of rules that map different problem classifications to corresponding base remediation recommendations (e.g., full refund, partial refund, full credit, etc.). The online system 140 may for each item, of the identified one or more items, apply the problem classification for the item to the set of rules to determine a corresponding base remediation recommendation for the item. The online system 140 may adjust the base remediation recommendation based in part on the quantity of the item. In some embodiments, the adjusted base remediation recommendations for each of the one or more items together form the response recommendation.

The online system 140 may generate a response to the complaint using the response recommendation, and provide the response to the user client device 100. In other embodiments, the online system 140 gathers session information associated with the complaint and provides it to the agent device 150. The session information is information that may be used to determine a resolution to the complaint. The session information may include, e.g., some or all of the message data, the one or more items, and the response recommendation. The online system 140 may then receive a response to the complaint from the agent device 150 to provide to the user client device 100. In some embodiments, the online system 140 may send the response recommendation to the agent device 150 for review by the human agent if one or more conditions are met, and if not, send the response recommendation directly to the user client device 100 as the response to the complaint.

The online system 140 may proceed in accordance with the response without express approval of the response from the user. In other embodiments, the response provided to the user client device 100 may include a request to approve the response, and based on receiving approval from the user client device 100, the online system 140 proceeds in accordance with the response.

For example, a user may have ordered a large number of different items of various quantities, where the order included 20 packages of Island Free Range eggs. Once the ordered was delivered, the user noticed that 10 of the packages of Island Free Range eggs were broken. The user may take some images of the broken packages of eggs and submit one or more messages to the online system 140 that describe a complaint about the order. The one or more messages may include the images and some additional context (e.g., structured data or unstructured data describing the complaint) from the user about the order.

The online system 140 gathers message data (e.g., context about the complaint, order data for the order, item data for items in the order, the images, etc.). The online system 140 may prompt the complaint analysis model based in part on the message data to identify one or more items of the order that are relevant to the complaint, quantities of the identified one or more items, and one or more problem classifications for the identified one or more items. In this example, responsive to the prompt, the complaint analysis model may identify an item (package of Island Free Range eggs) that was the cause of the complaint, a quantity of the identified item (e.g., 10 packages of Island Free Range eggs that included broken eggs), and a problem classification for the identified item.

The online system 140 may determine, for a package of Island Free Range eggs, a response recommendation based in part on the problem classification and the quantity (e.g., 10) of the Island Free Range package of eggs relevant to the complaint. The online system 140 may apply a problem classification for a package of Island Free Range eggs to the set of rules to determine a corresponding base remediation recommendation (e.g., refund, credit, etc.). The online system 140 may adjust the base remediation recommendation based in part on the quantity (e.g., 10) of the broken packages of Island Free Range eggs. For example, the adjustment may be such that that the base recommendation is for each of the broken packages of Island Free Range eggs. The adjusted base remediation recommendation may form a response recommendation for the complaint. In some embodiments, the online system 140 may provide the response recommendation to the user client device 100. In other embodiments, the online system 140 gathers session information including the response recommendation and provides it to the agent device 150 for review by a human agent. The human agent may review the session information and determine a response to the complaint based in part on the session information. The human agent may then instruct the online system 140 (e.g., via the agent device 150) to provide the response to the user client device 100. In some embodiments, the online system 140 may send the response recommendation to the human agent for review if one or more conditions are met (e.g., total cost of appeasement is more than a threshold amount), and if not, send the response recommendation directly to the user client device 100 as the response to the complaint.

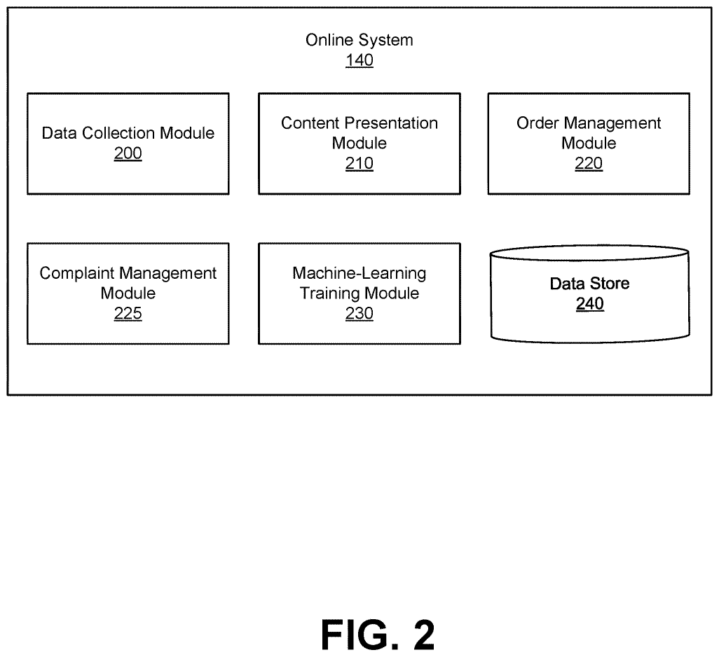

In the above manner, the online system 140 is able to leverage using the complaint analysis model to facilitate providing consistent and accurate responses to complaints in a time efficient manner. This can be particularly helpful for responding to complaints relating to large or complex orders which can be difficult tasks for human agents to perform in a consistent, accurate, and time efficient manner. For example, instead of a 10 packages of broken eggs, there were multiple items relevant to the complaint that each have different quantities, the framework described herein using the complaint analysis model is able to quickly and accurately formulate a response recommendation which less chance of error than a purely human agent based approach. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a complaint management module 225, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The data collection module 200 also gathers message data that are associated with complaints. Message data may be data that describes a complaint about an order associated with a user. Message data may include, e.g., context about a complaint, order data for an order associated with the complaint, item data for items in the order, picker data associated with the order, one or more images (e.g., images of spoiled produce, damaged packaging, etc.) associated with a complaint that are provided by the user client device 100, some other information about the complaint, or some combination thereof. The context may include, e.g., structured data or unstructured data describing the complaint, transcript from an online chat session with the user regarding the complaint, transcript from an online chat session between the user and a picker who assembled the order, some other context about the complaint, or some combination thereof. The data collection module 200 may store gathered message data in the data store 240.

While user data, picker data, source data, item data, order data, and message data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The complaint management module 225 may communicate with user client devices via one or more communication channels regarding complaints. A communication channel may be, e.g., an online chat session, email, phone, text, some other means of communicating with the user client device, or some combination thereof. The complaint management module 225 may, e.g., maintain an online chat session with a user client device 100, where the online chat session includes one or more rounds of messaging to gather context about the complaint. The complaint management module 225 may gather message data associated with one or more messages between a user client device and the online system 140 regarding a complaint about an order. In some embodiments, the data collection module 200 gathers the message data and the complaint management module 225 retrieves the message data from the data store 240.

The complaint management module 225 processes complaints received from user client devices. The complaint management module 225, for a given complaint, determines a prompt that is based in part on the message data. The prompt is for a complaint analysis model. The complaint analysis model is a machine learning model (e.g., large-language model) that may process the message data using, e.g., natural language understanding, image recognition, and contextual analysis to assess a complaint. The complaint analysis model may cross-reference some of the message data (e.g., order data, item data, picker data) in order to identify specific items that are relevant to the complaint (e.g., are why the complaint was submitted), their quantities, and their respective problem classifications. As such, the complaint management module 225 applies the prompt to the complaint analysis model to cause it to identify one or more items of the order that are relevant to the complaint, determine quantities of the identified one or more items, and determine at least one problem classification for each of the identified one or more items. In some embodiments, an item may have multiple problem classifications.

A problem classification describes how severely an item that is relevant to the complaint (e.g., missing item, damaged item, wrong item, timeliness of delivery, etc.) differs from what was actually ordered. The problem classification may be based on one or more factors. The factors may include, e.g., a similarity score between the item that was actually delivered and the item that was ordered, a level of damage of the item at delivery, whether the item was expired or spoiled at delivery, whether the item was missing from the delivery, whether a wrong quantity of the item was delivered, a timelines of delivery of the item, some other criterion for accessing how severely an item relevant to the complaint differs from what was actually ordered, or some combination thereof. In some embodiments, a problem classification is based on a weighted combination of values from a plurality of different factors. In some embodiments, the problem classification may be a represented using a score (e.g., determined from values of one or more factors). For example, the problem classification may be a score that has a range from, e.g., 0 to 1, with 0 representing a least severe problem associated with an item relevant to the complaint, and 1 representing a most severe problem associated with an item relevant to the complaint.

The complaint management module 225 determines response recommendations for identified items based in part on their quantities and problem classifications. In some embodiments, for a given set of identified items that are relevant to a complaint, the complaint management module 225 determines, for each item of the set of identified items, a corresponding base remediation recommendation based in part on a problem classification for that item. A base remediation recommendation describes a form of recommended appeasement. A base remediation recommendation may be, e.g., replace an item at no charge, provide a partial refund, provide a full refund for the item, provide a partial credit, provide a full credit, some other form of appeasement, or some combination thereof. In some embodiments, the complaint management module 225 may retrieve a set of rules (e.g., from the data store 240) that map different problem classifications to corresponding base remediation recommendations. The complaint management module 225 may, for each identified item, of the identified one or more items, apply a problem classification for the identified item to the set of rules to determine a corresponding base remediation recommendation. The complaint management module 225 may adjust the base remediation recommendation based in part on a quantity of the identified item.

For example, if the base remediation recommendation is to refund a partial amount of a price of the identified item, and there were “x” number of the identified item in the order, the complaint management module 225 may multiply the base remediation recommendation by a factor of “x” to determine the adjusted base remediation recommendation. In some embodiments, the response recommendation is formed from the adjusted base remediation recommendations. A response recommendation is a recommendation describing how the online system 140 responds to a complaint. For example, for a given complaint, there may be an adjusted base remediation for each identified item. The complaint management module 225 may generate a response recommendation that details the adjusted based recommendations for the complaint.

In one or more other embodiments, the complaint analysis model may directly output a response recommendation along with the one or more items of the order that are relevant to the complaint and their quantities. For example, the complaint management module 225 may prompt the complaint analysis model with the message data to identify one or more items of the order that are relevant to the complaint, determine quantities of the identified one or more items, and determine a response recommendation to the complaint.

The complaint management module 225 may generate responses to complaints using determined response recommendations. For example, responses may be the determined response recommendations, and the online system 140 provides the responses to the user client devices.

In some embodiments, the complaint management module 225 first provides generated response recommendations to human agents for review before responses to the complaints are provided. For example, for a given complaint, the complaint management module 225 may gather session information (e.g., some or all of the message data, the identified one or more items, and the response recommendation) associated with the complaint. The online system 140 may provide the session information to an agent device 150 associated with a human agent. The human agent may then review the response recommendation along with other relevant information from the session information. In some embodiments, the online system 140 may also provide an option for the human agent to approve or disregard the response recommendation. The online system 140 may then receive a response to the complaint from the agent device 150 to provide to the user client device 100.

In some embodiments, the online system 140 may send the response recommendation to the human agent for review if one or more conditions (e.g., a total cost of appeasement is more than a threshold amount) are met, and if not, send the response recommendation directly to the user client device 100 as the response to the complaint. A conditions may be, e.g., a total cost of appeasement is more than a threshold amount.

The online system 140 may proceed in accordance with the response to the complaint without express approval of the user. In other embodiments, the complaint management module 225 may include in the response provided to the user client device 100 a request to approve the response, and based on receiving approval from the user client device 100, the online system 140 proceeds in accordance with the response.

In some embodiments, the complaint management module 225 notifies user client devices that their complaints have been transferred to human agents. In some embodiments, the complaint management module 225 may hand off an online chat session to the agent device 150 associated with the human agent. In this manner, the human agent may be able to provide a response to the complaint to the user client device during the online chat session. In other embodiments, the human agent provides the response to the user client device sometime after the online chat session via a communication channel (e.g., email, phone, etc.). For example, once the complaint management module 225 transfers the question to the human agent, it may also notify the user client device of the transfer and let them know a ticket has been created for their complaint and that the human agent will contact them with a response.

The machine-learning training module 230 trains machine-learning models used by the online system 140 (e.g., the complaint analysis model). The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, order data, response recommendation data, or message data, which may be referred to respectively as training user data, training picker data, training item data, training order data, training response recommendation data, and training message data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may train the complaint analysis model by accessing a set of training examples that includes training message data, training order data, training item data, training response recommendation data, and in some cases may also include training picker data. The machine-learning training module 230 may apply the complaint analysis model to the set of training examples to generate a training output corresponding to a set of response recommendations. The machine-learning training module 230 may back-propagate one or more error terms obtained from one or more loss functions to update a set of parameters of the complaint analysis model, and one or more of the error terms are based on a difference between a label applied to a test interaction of the set of training examples and the set of response recommendations. The machine-learning training module 230 may stop the back-propagation after the one or more loss functions satisfy one or more criteria.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

For example, the machine-learning training module 230 may fine-tune or retrain the complaint analysis model based on feedback associated with complaints. For example, the machine-learning training module 230 may receive feedback on complaints from user client devices, agent devices, or both. The feedback from a user associated with a user client device may describe, e.g., how satisfied a user is with a response to the complaint, how accurate the response is in identifying items relevant to the complaint, how accurate the response is identifying a quantity of each of the items relevant to the complaint, etc. The feedback from a human agent associated with an agent device may describe, e.g., how close a response recommendation generated by the online system 140 is to a response that was actually sent to the user client device associated with the complaint, how accurate the response is in identifying items relevant to the complaint, how accurate the response is identifying a quantity of each of the items relevant to the complaint, etc. The machine-learning training module 230 may generate additional training examples based in part on the feedback from the agent devices, the user client devices, lengths of time associated with resolving complaints, or some combination thereof. The machine-learning training module 230 may fine tune the complaint analysis model using the additional training examples.

The data store 240 stores data used by the online system 140. For example, the data store 240 stores user data, item data, order data, picker data, message data, response recommendations, items relevant to complaints, quantities of items relevant to complaints, session information, and rules (e.g., that map different problem classifications to corresponding base remediation recommendations) for use by the online system 140. The data store 240 also stores trained machine-learning models (e.g., the complaint analysis model) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

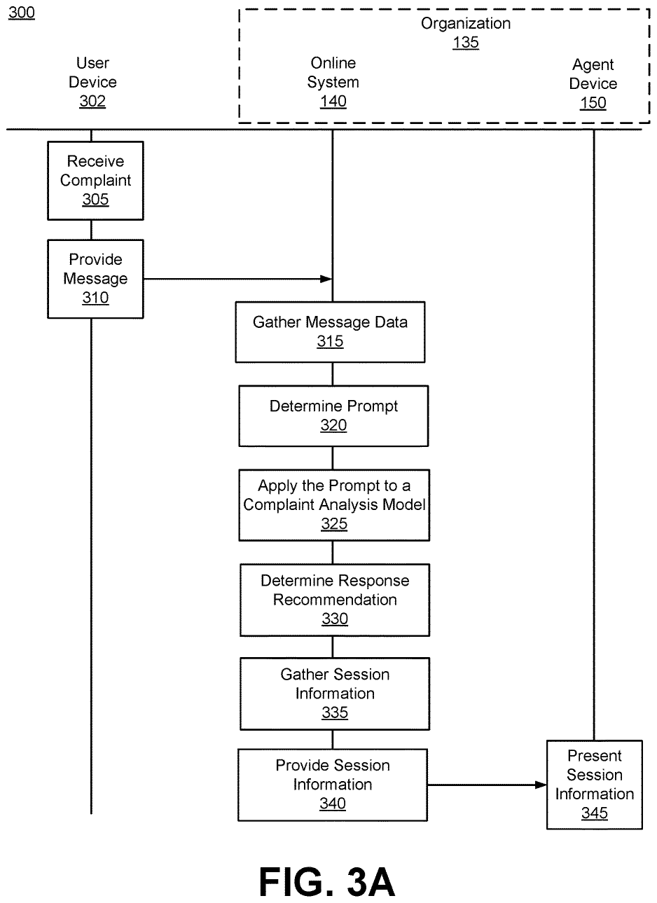

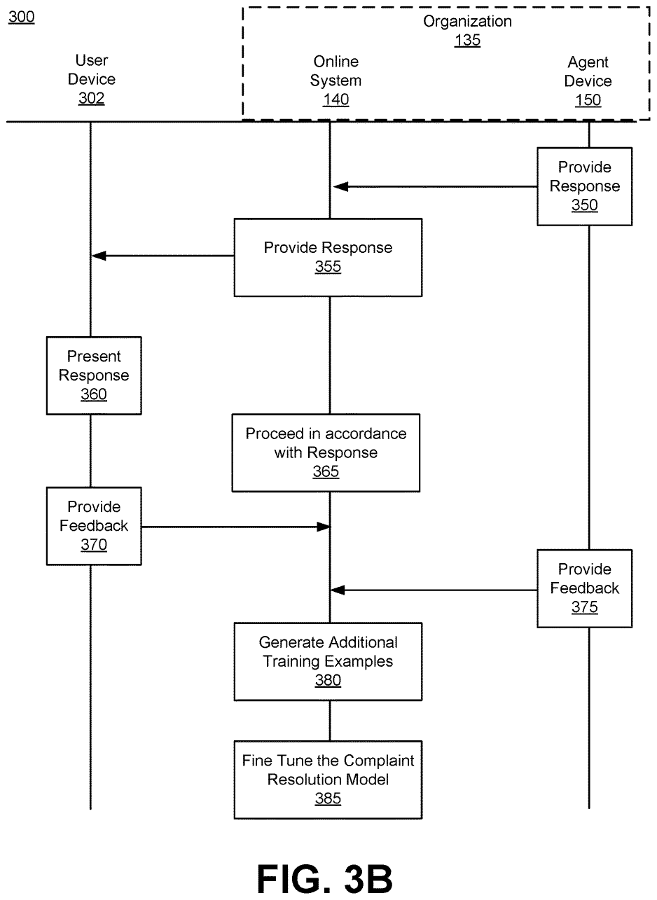

FIGS. 3A-3B form an example sequence diagram 300 for responding to complaints based in part on classifications of items using a complaint analysis model, in accordance with some embodiments. Alternative embodiments may include more, fewer, or different interactions from those illustrated in FIGS. 3A-3B, and the steps may be performed in a different order from that illustrated in FIGS. 3A-3B.

A user device 302 (e.g., the user client device 100) receives 305 a complaint about an order from a user. The complaint may include structured or structured information describing one or more problems with the order. The complaint may also include one or more images of items associated with the complaint. For example, the user may take pictures of damaged items, and include these images in the complaint. The user device 302 provides 310 a message including the complaint to the online system 140.

The online system 140 gathers 315 message data associated with the message. In some embodiments, the complaint management module 225 of the online system 140 gathers the message data (e.g., context about the complaint, order data for the order, item data for items in the order, picker data associated with the order, the one or more images, etc.) from the message or a data store (e.g., the data store 240). In some embodiments, the complaint management module 225 may retrieve the message data from a data store (e.g., the data store 240) or a data collection module (e.g., the data collection module 200).

The online system 140 determines 320 a prompt for a complaint analysis model. For example, the complaint management module 225 may determine a prompt to cause the complaint analysis model to identify one or more items of the order that are relevant to the complaint, determine quantities of the identified one or more items, and determine at least one problem classification for each of the identified one or more items. The online system 140 applies 325 the prompt to the complaint analysis model. Responsive to the prompt, the complaint analysis model outputs one or more items that are relevant to the complaint, quantities of those items, and one or more problem classifications for each of the one or more items.

The online system 140 determines 330 a response recommendation for the identified one or more items. For example, the complaint management module 225 may retrieve a set of rules (e.g., from the data store 240) that map different problem classifications to corresponding base remediation recommendations. The complaint management module 225 may, for each item, of the identified one or more items, apply a problem classification for the item to the set of rules to determine a corresponding base remediation recommendation (e.g., replace an item at no charge, provide a partial refund, provide a full refund for the item, provide a partial credit, provide a full credit, etc.). The complaint management module 225 may adjust the base remediation recommendation based in part on a quantity of the item. For example, if the base remediation recommendation is to replace an item, and there were “x” number of the identified item in the order, the complaint management module 225 may apply the base remediation to each of the “x” items to form an adjusted base remediation recommendation (e.g., replacing x of the identified item). In some embodiments, the adjusted base remediation recommendations for the identified one or more items form the response recommendation for the complaint. In one or more other embodiments, In one or more other embodiments, the complaint analysis model may also directly output the response recommendation at step 325.

In some embodiments, the online system 140 may gather 335 session information associated with the complaint. For example, the complaint management module 225 may gather (e.g., from the data store 240) some or all of the message data, the identified one or more items, and the response recommendation, etc., as the session data. The online system 140 may provide 340 the session information to the agent device 150.

The agent device 150 presents 345 at least some of the session information. A human agent associated with the agent device 150 reviews the session information and determines a response to the complaint based in part on the session information. In some embodiments, the response recommendation is presented via the agent device 150 to the human agent along with an option for the human agent to approve or disregard the response recommendation. And if the human agent approves the response recommendation, the agent device 150 may coordinate with the online system 140 to provide a response to the user client device 100 describing the response recommendation (e.g., refunding money for the defective items).

The agent device 150 may provide 350 the response to the online system 140, which provides 355 the response to the user device 302. In some embodiments, the agent device 150 instead provides the response directly to the user device 302. In some embodiments, the response is provided as part of an online chat session between the online system 140 and the user device 302. In other embodiments, the response is provided some time after the online chat session has terminated via a communication channel (e.g., email, online chat session, phone, etc.).

In some embodiments, the online system 140 provides the response recommendation directly to the user device 302 as a response to the complaint without sending it to the agent device 150. In this example, the online system 140 proceeds from step 330 directly to step 355, without performing steps 335, 340, 345, and 350. While not shown in FIG. 3B, in some embodiments, the online system 140 may send the response recommendation to the agent device 150 for review by the human agent if one or more conditions are met, and if not, sends the response recommendation directly to the user device 302 as the response to the complaint. The user device 302 presents 360 to the user the response to the complaint.

The online system 140 may proceed 365 in accordance with the response. In some embodiments, the online system 140 proceeds with the response without express approval of the response from the user. For example, if the response was to send an item that was missing from the order, the online system 140 proceeds with sending the missing item. In other embodiments, the response provided to the user device 302 at step 355 may include a request to approve the response, and based on receiving approval from the user device 302, the online system 140 proceeds in accordance with the response.

The user may review the response to the complaint and provide feedback (e.g., how satisfied the user is with the response, how accurate the response is in identifying items relevant to the complaint, how accurate the response is identifying a quantity of each of the items relevant to the complaint, etc.) to the user device 302. The user device 302 provides 370 the feedback from the user to the online system 140.

In some embodiments, the human agent may provide feedback (e.g., how close the response recommendation is to the response, how accurately the response identified items relevant to the complaint, how accurately the response identifies a quantity of each of the items relevant to the complaint, etc.) regarding performance of the online system 140 in handling the complaint. The agent device 150 may provide 375 the feedback from the user agent to the online system 140.

The online system 140 may generate 380 additional training examples using the feedback from the user, the feedback from the human agent, or both. For example, the online system 140 may use the machine-learning training module 230 to generate the additional training examples using the received feedback. The online system 140 may may fine tune 385 (e.g., using the machine-learning training module 230) the complaint analysis model using the additional training examples.

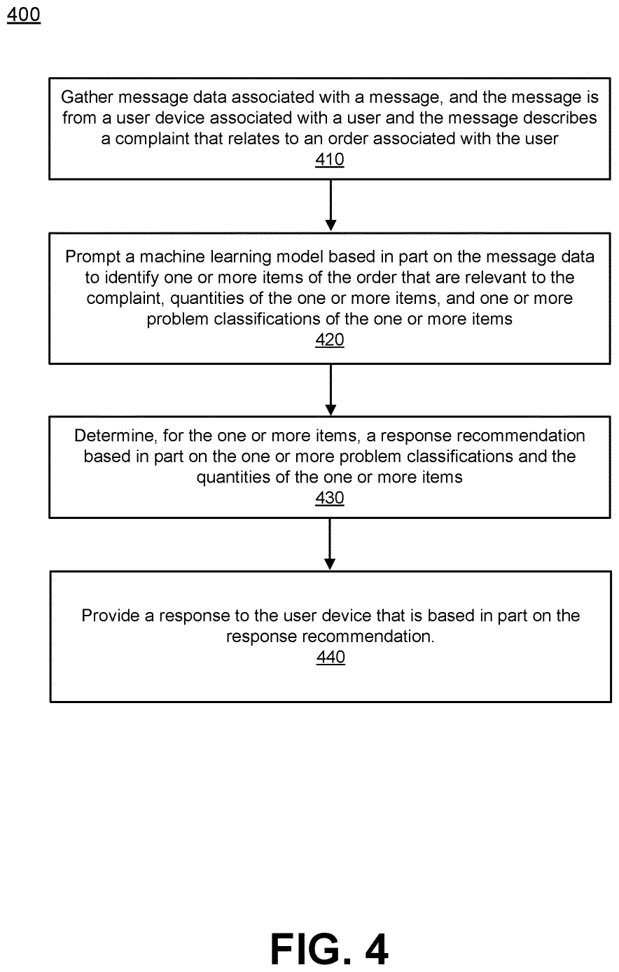

FIG. 4 is a flowchart 400 for a method of generating responses to complaints based in part on classifications of items using a complaint analysis model, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system gathers 410 message data associated with a message, and the message is from a user device associated with a user and the message describes a complaint that relates to an order associated with the user. In some embodiments, a complaint management module (e.g., the complaint management module 225) or a data collection module (e.g., the data collection module 200) of the online system 140 gathers the message data from the message or a data store (e.g., the data store 240).

The online system prompts 420 a complaint analysis model based in part on the message data to identify one or more items of the order that are relevant to the complaint, quantities of the one or more items, or one or more problem classifications of the one or more items. The complaint analysis model is a machine learning model (e.g., large language model). The online system 140 may generate the prompt, and apply the prompt to the complaint analysis model. Responsive to the prompt, the complaint analysis model outputs one or more items of the order that are relevant to the complaint, quantities of the one or more items, or one or more problem classifications of the one or more items.

The online system determines 430, for the one or more items, a response recommendation based in part on the one or more problem classifications and the quantities of the one or more items. The online system may retrieve a set of rules (e.g., from the data store 240) that map different problem classifications to corresponding base remediation recommendations. The online system may, for each item, of the one or more items, apply a problem classification for the item to the set of rules to determine a corresponding base remediation recommendation. The online system may adjust the base remediation recommendation based in part on a quantity of the item. In some embodiments, the adjusted base remediation recommendations of the one or more items form the response recommendation. In one or more other embodiments, the complaint analysis model may directly output a response recommendation along with the one or more items of the order that are relevant to the complaint and their quantities.

The online system provides 440 a response to the user device that is based in part on the response recommendation. In some embodiments, the response recommendation is the response, and the online system provides the response directly to the user device without sending it to an agent device for review by a human agent. In some embodiments, the online system provides the response recommendation to an agent device (e.g., the agent device 150) for review by a human agent. For example, the online system may gather session information (e.g., some or all of the message data, the identified one or more items, and the response recommendation) associated with the complaint, and provide the session information to an agent device. The online system may then receive a response to the complaint from the agent device that is based in part on the response recommendation, and the online system then provides the response to the user device. In some embodiments, the online system may send the response recommendation to the human agent for review if one or more conditions are met, and if not, send the response recommendation directly to the user device as the response to the complaint.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A method, performed at a computer system comprising a processor and a computer-readable medium, comprising:
fine-tuning a large language model (LLM) using generated training examples, the training examples generated by:
receiving a plurality of historical complaint records associated with prior user interactions, each complaint record comprising one or more complaint messages and corresponding order data;
identifying, for each historical complaint record, a ground truth dataset comprising at least one of: one or more items of the order that are related to the complaint, quantities of the one or more items, or one or more problem classifications associated with the one or more items; and
generating training examples by associating the complaint messages and the corresponding order data with the respective ground truth datasets;
gathering message data associated with a message, wherein the message is from a user device associated with a user and the message describes a complaint that relates to an order associated with the user, wherein gathering the message data comprises retrieving order data associated with the order and item data associated with items of the order, and wherein the message data includes the order data and the item data;
prompting the LLM based in part on the message data to identify one or more items of the order that are relevant to the complaint, quantities of the one or more items, or one or more problem classifications of the one or more items;
generating, for the one or more items, a response recommendation based in part on the one or more problem classifications and the quantities of the one or more items, wherein each response recommendation comprises a corresponding remediation recommendation based on a problem classification for the respective item and adjusted based on a quantity of the respective item; and
transmitting a response to the user device that is based in part on the response recommendation, the transmitting causing the user device to display the response recommendation.

2. (canceled)

3. The method of claim 1, further comprising:
gathering session information, including at least some of the message data, the one or more items, and the response recommendation;
transmitting the session information to an agent device associated with a human agent; and
receiving, from the agent device, the response to the complaint, wherein the response is based in part on the session information.

4. The method of claim 3, further comprising:
receiving feedback from the agent device on the response recommendation;
receiving feedback from the user device on the response;
generating additional training examples based in part on the feedback from the agent device and the feedback from the user device; and
fine tuning the LLM using the additional training examples.

5. The method of claim 4, further comprising:
generating a length of time associated with resolving the complaint;
wherein generating the additional training examples based in part on the feedback from the agent device and the feedback from the user device, comprises generating the additional training examples based in part on the feedback from the agent device, the feedback from the user device, and the length time.

6. The method of claim 1, wherein generating, for the one or more items, the response recommendation based in part on the one or more problem classifications and the quantities of the one or more items, comprises:
retrieving a set of rules that map different problem classifications to corresponding base remediation recommendations; and
for each item, of the one or more items,
applying a problem classification for the item to the set of rules to generate a corresponding base remediation recommendation, and
adjusting the base remediation recommendation based in part on a quantity of the item,
wherein the adjusted base remediation recommendations for each of the one or more items together form the response recommendation.

7. The method of claim 1, wherein the message data includes an image of an item of the one or more items, and gathering the message data associated with the message, comprises:
retrieving order data associated with the order and item data associated with items of the order, wherein the message data includes the order data and the item data,
wherein prompting the LLM based in part on the message data to identify the one or more items of the order that are relevant to the complaint, the quantities of the one or more items, and the one or more problem classifications of the one or more items, comprises prompting the LLM based in part on the order data, the item data, and the image.

8. The method of claim 1, wherein gathering the message data associated with the message, comprises:
maintaining an online chat session with the user device, the online chat session including one or more rounds of messaging to gather context about the complaint; and
retrieving order data associated with the order and item data associated with items of the order, wherein the message data includes at least some of the context, the order data, and the item data,
wherein prompting the LLM based in part on the message data to identify the one or more items of the order that are relevant to the complaint, the quantities of the one or more items, and the one or more problem classifications of the one or more items, comprises prompting the LLM based in part on the order data, the item data, and at least some of the context.

9. The method of claim 1, wherein gathering the message data associated with the message, comprises:
retrieving structured data from the message; and
retrieving order data associated with the order and item data associated with items of the order, wherein the message data includes the structured data, the order data, and the item data,
wherein prompting the LLM based in part on the message data to identify the one or more items of the order that are relevant to the complaint, the quantities of the one or more items, and the one or more problem classifications of the one or more items, comprises prompting the LLM based in part on the order data, the item data, and at least some of the structured data.

10. A computer program product comprising a non-transitory computer readable storage medium having instructions encoded thereon that, when executed by a processor of a computer system, cause the computer system to perform steps comprising:
fine-tuning a large language model (LLM) using generated training examples, the training examples generated by:
receiving a plurality of historical complaint records associated with prior user interactions, each complaint record comprising one or more complaint messages and corresponding order data;
identifying, for each historical complaint record, a ground truth dataset comprising at least one of: one or more items of the order that are related to the complaint, quantities of the one or more items, or one or more problem classifications associated with the one or more items; and
generating training examples by associating the complaint messages and the corresponding order data with the respective ground truth datasets;
gathering message data associated with a message, wherein the message is from a user device associated with a user and the message describes a complaint that relates to an order associated with the user, wherein gathering the message data comprises retrieving order data associated with the order and item data associated with items of the order, and wherein the message data includes the order data and the item data;
prompting the LLM based in part on the message data to identify one or more items of the order that are relevant to the complaint, quantities of the one or more items, or one or more problem classifications of the one or more items;
generating, for the one or more items, a response recommendation based in part on the one or more problem classifications and the quantities of the one or more items. wherein each response recommendation comprises a corresponding remediation recommendation based on a problem classification for the respective item and adjusted based on a quantity of the respective item; and
transmitting a response to the user device that is based in part on the response recommendation, the transmitting causing the user device to display the response recommendation.

11. (canceled)

12. The computer program product of claim 10, further comprising encoded instructions that when executed cause the computer system to perform steps comprising:
gathering session information including at least some of the message data, the one or more items, and the response recommendation;
transmitting the session information to an agent device associated with a human agent; and
receiving, from the agent device, the response to the complaint, wherein the response is based in part on the session information.

13. The computer program product of claim 12, further comprising encoded instructions that when executed cause the computer system to perform steps comprising:
receiving feedback from the agent device on the response recommendation;
receiving feedback from the user device on the response;
generating additional training examples based in part on the feedback from the agent device and the feedback from the user device; and
fine tuning the LLM using the additional training examples.

14. The computer program product of claim 13, further comprising encoded instructions that when executed cause the computer system to perform steps comprising:
generating a length of time associated with resolving the complaint;
wherein generating the additional training examples based in part on the feedback from the agent device and the feedback from the user device, comprises generating the additional training examples based in part on the feedback from the agent device, the feedback from the user device, and the length time.

15. The computer program product of claim 10, wherein the encoded instructions for generating, for the one or more items, the response recommendation based in part on the one or more problem classifications and the quantities of the one or more items cause the computer system to perform steps comprising:
retrieving a set of rules that map different problem classifications to corresponding base remediation recommendations; and
for each item, of the one or more items,
applying a problem classification for the item to the set of rules to generate a corresponding base remediation recommendation, and
adjusting the base remediation recommendation based in part on a quantity of the item, wherein the adjusted base remediation recommendations for each of the one or more items together form the response recommendation.

16. The computer program product of claim 10, wherein the message data includes an image of an item of the one or more items, and wherein the encoded instructions for gathering the message data associated with the message cause the computer system to perform steps comprising:
retrieving order data associated with the order and item data associated with items of the order, wherein the message data includes the order data and the item data,
wherein the encoded instructions for prompting the LLM based in part on the message data to identify the one or more items of the order that are relevant to the complaint, the quantities of the one or more items, and the one or more problem classifications of the one or more items cause the computer system to perform steps comprising prompting the LLM based in part on the order data, the item data, and the image.

17. The computer program product of claim 10, wherein the encoded instructions for gathering the message data associated with the message cause the computer system to perform steps comprising:
maintaining an online chat session with the user device, the online chat session including one or more rounds of messaging to gather context about the complaint; and
retrieving order data associated with the order and item data associated with items of the order, wherein the message data includes at least some of the context, the order data, and the item data,
wherein the encoded instructions for prompting the LLM based in part on the message data to identify the one or more items of the order that are relevant to the complaint, the quantities of the one or more items, and the one or more problem classifications of the one or more items cause the computer system to perform steps comprising prompting the LLM based in part on the order data, the item data, and at least some of the context.

18. The computer program product of claim 10, wherein the encoded instructions for gathering the message data associated with the message cause the computer system to perform steps comprising:
retrieving structured data from the message; and
retrieving order data associated with the order and item data associated with items of the order, wherein the message data includes the structured data, the order data, and the item data,
wherein the encoded instructions for prompting the LLM based in part on the message data to identify the one or more items of the order that are relevant to the complaint, the quantities of the one or more items, and the one or more problem classifications of the one or more items cause the computer system to perform steps comprising prompting the LLM based in part on the order data, the item data, and at least some of the structured data.

19. A computer system comprising:
a processor; and
a non-transitory computer readable storage medium having instructions encoded thereon that, when executed by the processor, cause the computer system to perform steps comprising:
fine-tuning a large language model (LLM) using generated training examples, the training examples generated by:
receiving a plurality of historical complaint records associated with prior user interactions, each complaint record comprising one or more complaint messages and corresponding order data;
identifying, for each historical complaint record, a ground truth dataset comprising at least one of: one or more items of the order that are related to the complaint, quantities of the one or more items, or one or more problem classifications associated with the one or more items; and
generating training examples by associating the complaint messages and the corresponding order data with the respective ground truth datasets;
gathering message data associated with a message, wherein the message is from a user device associated with a user and the message describes a complaint that relates to an order associated with the user, wherein gathering the message data comprises retrieving order data associated with the order and item data associated with items of the order, and wherein the message data includes the order data and the item data,
prompting the LLM based in part on the message data to identify an items of the order that is relevant to the complaint, a quantity of the item, or a problem classification of the item,
generating, for the item, a response recommendation based in part on the problem classification and the quantity of the item, wherein the response recommendation comprises a corresponding remediation recommendation based on the problem classification for the item and adjusted based on the quantity of the item, and
transmitting a response to the user device that is based in part on the response recommendation, the transmitting causing the user device to display the response recommendation.

20. The computer system of claim 19, wherein the encoded instructions for generating, for the item, the response recommendation based in part on the problem classification and the quantity of the item cause the computer system to perform steps comprising:
retrieving a set of rules that map different problem classifications to corresponding base remediation recommendations;
applying a problem classification for the item to the set of rules to generate a corresponding base remediation recommendation; and
adjusting the base remediation recommendation based in part on a quantity of the item, wherein the adjusted base remediation recommendation is the response recommendation.
